(19) United States
(12) Patent Application Publication
(10) Pub. No.: US 2003/0160125 A1
(43) Pub. Date: Aug. 28, 2003

(54) Retractor for capturing wire or cable

(76) Inventor: Joseph F. Siana JR., Tulsa, OK (US)

Correspondence Address: ROLAND O. COX, 9550 SO. COLLEGE COURT, TULSA, OK, 74137, US

(21) Appl. No.: 10/084,079

(22) Filed: Feb. 27, 2002

(51) Int. Cl. B65H 75/38; H02G 3/22

(52) U.S. Cl. 242/395; 254/134.3 FT

(57) ABSTRACT

A Retractor device for capturing wire within an enclosed space and extracting the wire outside the space. The device utilizes a flexible tape coiled around a spool in the device housing.

### BACKGROUND OF THE INVENTION

This invention is directed to an improved Retractor device for capturing and removing wires, cables and the like, which are run through walls or enclosed spaces. Particularly, the present invention is directed toward a Retractor, which will quickly and efficiently capture any wire or cable in a wall or other enclosed space by means of an extendable and retractable flexible tape.

For purposes of this application “wire” or “wiring” means electrical wire, telecommunications wiring or cable and any other wire, cable, flexible tubular or the like which is run with in a wall or other enclosed space.

When an electrical or telephone outlet or the like is to be installed, it is common practice to run necessary wiring within a wall or other enclosed space to a location on the wall outside the enclosed space where the outlet is to be placed. After wiring has been run in a wall or other enclosed space, it must be captured and removed or passed from a closed space through the wall for connection to the outlet.

A number of devices have been developed to aid in running wire in a wall or closed space as listed in U.S. Pat. No. 5,957,399 issued Sep. 28, 1999, and herein incorporated for reference.

A simpler and improved Retractor device is needed for capturing wire or the like in a wall or enclosed space and extracting it therefrom.

### SUMMARY OF THE INVENTION

The present invention is an improved and simplified Retractor device, which captures wire within a wall or enclosed space for removal (extraction) from the space for connection outside the enclosure. This Retractor device includes a flexible tape coiled around a spool in the Retractor housing. One end of the coiled tape is anchored in an extension of the housing to form a closed loop with the housing extension; the other end of the tape is attached to the spool. The spool includes ridges extending therefrom by which the spool may be rotated to extend or retract the tape to form a larger or smaller closed loop with the housing. The housing has a window through which graduations on the tape may be viewed.

In use, the housing extension is inserted into an enclosed space through an opening made in the enclosed space. The spool is rotated to extend the tape and form a larger loop in the enclosed space. After a wire to be captured is passed into the enclosed space and tape loop, the spool is rotated to retract the tape into the housing capturing the wire between housing extension and the tape. The housing extension with captured wire may now be removed from the opening in the enclosed space, extracting the wire for connection outside.

An objective of this invention is to provide a wire Retractor which may be quickly and easily operated to capture a wire within an enclosed space and extract the wire from the enclosed space.

Also an object of this invention is to provide a Retractor which has a window in the Retractor housing for viewing graduations on a coiled tape which is utilized to capture the wire.

Another object of this invention is to provide a simplified wire Retractor device having fewer parts.

Another object of this invention is to provide a Retractor, which is more economical to manufacture.

### DESCRIPTION OF THE DRAWINGS

FIG. 1 is a cross sectional plan view of the present invention along line 1-1 of FIG. 2.

FIG. 2 is a cross sectional view of the invention Retractor along line 2-2 of FIG. 1.

FIG. 3 is a view in partial section showing the present invention in operating position with flexible tape extended in a typical enclosed space.

FIG. 4 is a view in partial section showing the Retractor flexible tape retracted capturing a wire and the present invention Retractor with captured wire being extracted from an enclosed space.

### DESCRIPTION OF THE PREFERRED EMBODIMENT

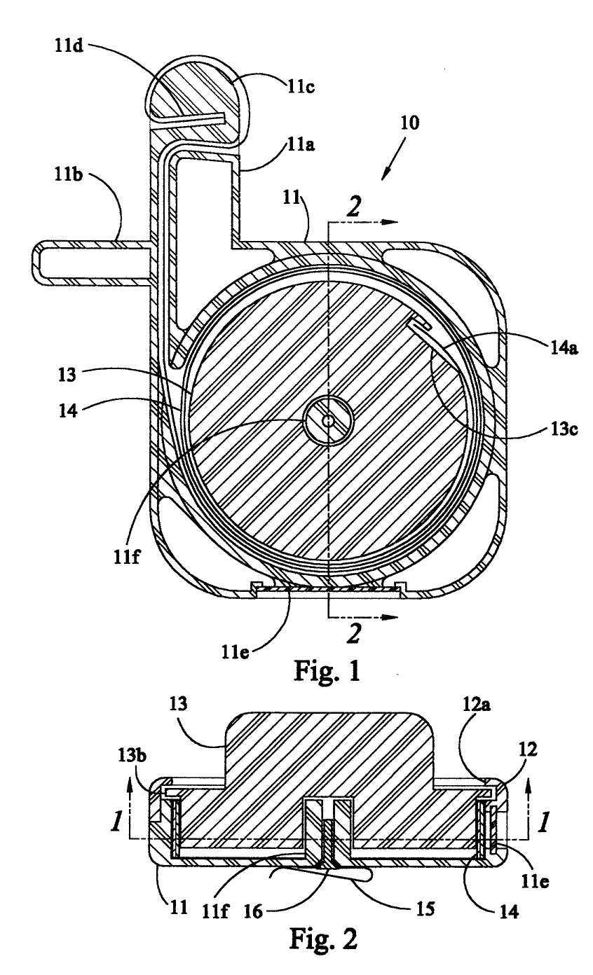

Referring to FIG. 1 which shows the invention Retractor device 10 has a lower housing 11 with an extension 11a and a positioning shoulder 11b. The extension has a radiused surface 11c. Retained in the lower housing 11 by upper housing 12 (FIG. 2) is a spool 13 around which is coiled a flexible tape 14. The tape is anchored by friction to housing 11 in slot 1d and around radiused surface 11c. The other end of tape 14 is connected to spool 13 by a tab 14a on tape 14 which is pressed into recess 13c on spool 13 by coils of tape 14. Housing 11 also has a window 11e through which graduations on tape 14 may be seen.

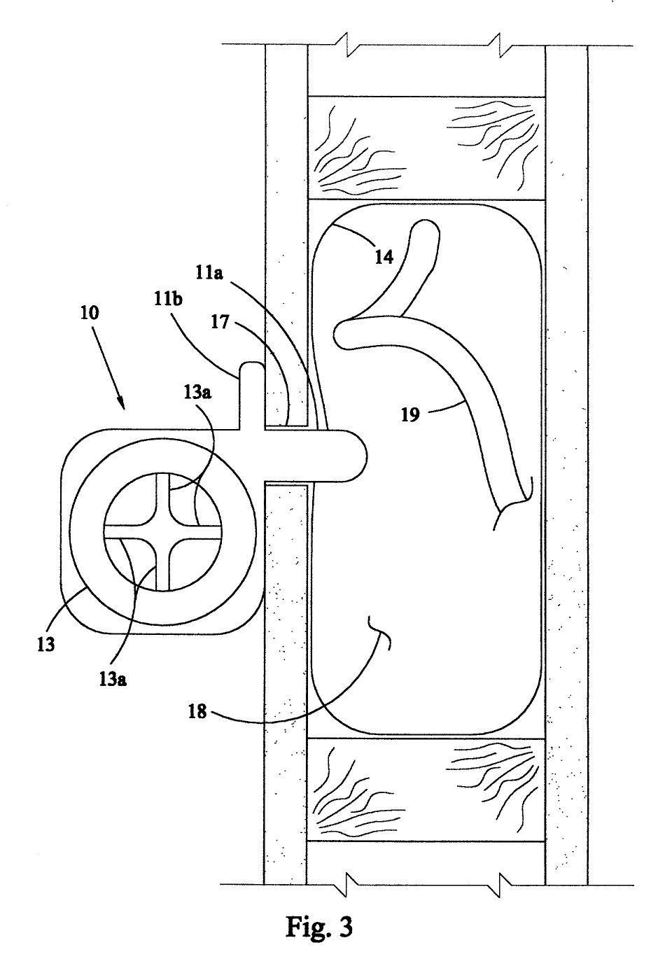

The lower housing has an axle 11f about which spool 13 may be rotated by ridges 13a (See FIG. 3). FIG. 2 shows the spool has a flange 13b and is rotatably retained in the lower housing by upper housing flange 12a.

A belt clip 15 may be connected to lower housing 11 by a pin or screw 16.

In use, FIG. 3 shows the present invention housing extension 11a has been positioned by shoulder 11b to protrude through opening 17 into a typical enclosed space 18 and spool 13 has been rotated to extend flexible tape 14 to form a large loop in the enclosed space.

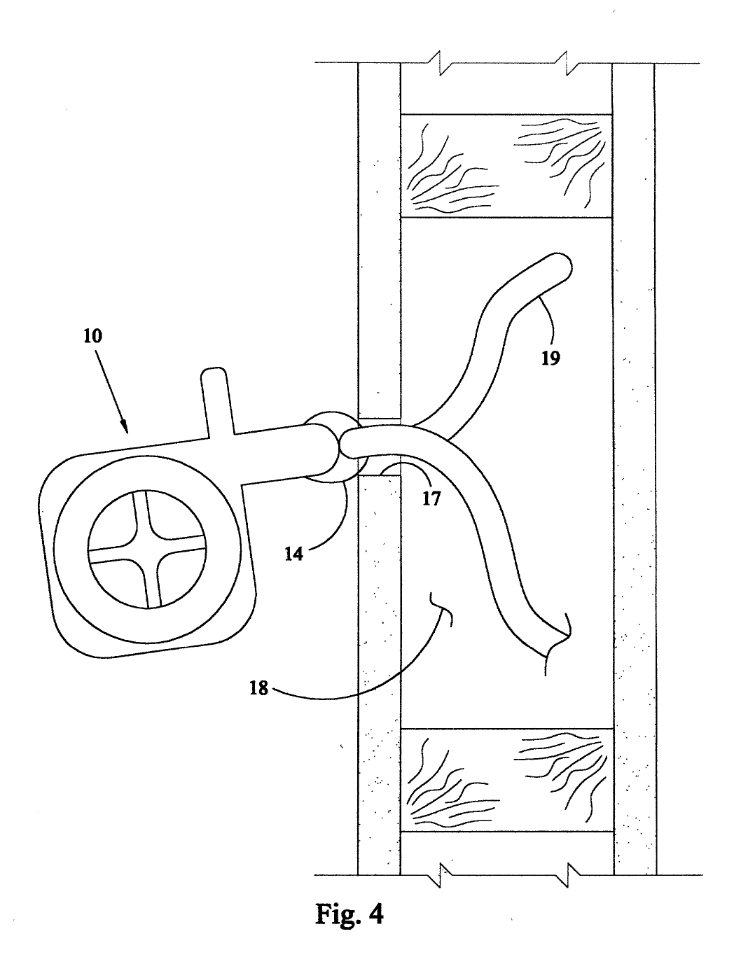

Next, an end of the wire 19 to be captured is passed into the enclosed space and the extended loop. Now, spool 13 is turned in a direction retracting tape 14 to capture wire 19. The improved wire Retractor device 10 may now be removed from opening 17 extracting the captured wire 19 outside the enclosed space 18 for connection as show in FIG. 4.

What I claim is:

1. A device for capturing and retracting wire or cable and the like from an enclosed space comprising:
housing means having a spool rotatably mounted therein; a flexible tape coiled around said spool;
means for anchoring one end of said tape in said housing to form a closed loop therewith;
means for connecting the other end of said tape to said spool; and
means on said spool for rotating the spool to extend or retract said tape.

2. The device of claim 1 wherein the housing means includes an extension therefrom having a shoulder and means for anchoring the tape to the housing.

3. The device of claim 2 wherein the means for anchoring the tape to the housing are a radius on the housing extension and a slot therein.

4. The device of claim 1 wherein the means connecting the tape to the spool is a tab on the tape and a recess in the spool.

5. The device of claim 1 wherein means for rotating the spool are ridges on the spool.

6. The device of clam 5 wherein the housing includes a window therein.

7. The device of claim 1 wherein the housing and spool are formed of plastic.

8. A device for capturing and extracting wire or cable and the like from an enclosed space comprising:
a housing having a window therein, an extension with a radius, thereon and a slot is said extension;
a spool ratably mounted in said housing having ridges extending therefrom;
a flexible tape coiled around said spool, one end of said tape around said extension radius and anchored in said extension slot, the other end of said tape having a tab pressed into a recess on said spool by said coiled tape, connecting said tape to said spool;
so that the spool may be rotated to extend said tape or retract it into said housing forming larger or smaller loops with said housing extension.

9. The device of claim 8 wherein the housing and spool are formed of plastic.
